(19) United States
(12) Patent Application Publication
(10) Pub. No.: US 2010/0309988 A1
(43) Pub. Date: Dec. 9, 2010

(54) ERROR CORRECTION IN DISTRIBUTED VIDEO CODING

(75) Inventors: Axel Lakus-Becker, New South Wales (AU); Ka-Ming Leung, New South Wales (AU)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Ohta-ku, Tokyo (JP)

(21) Appl. No.: 12/680,224

(22) PCT Filed: Dec. 9, 2008
(86) PCT No.: PCT/AU08/01815

§ 371 Date: Jul. 19, 2010

(30) Foreign Application Priority Data
Dec. 12, 2007 (AU) 2007242924

(51) Int. Cl. H04N 7/64

(52) U.S. Cl. 375/240.27; 375/E07.279

(57) ABSTRACT

Methods (700, 800) for encoding an input video frame (1005) comprising a plurality of pixel values, to form an encoded video frame, are disclosed. The pixel values of the input video frame (1005) are down-sampled to generate a first stream of bits configured for use in subsequent determination of approximations of the pixel values. Samples from predetermined pixel positions of the input video frame (1005) are extracted to generate a second stream of bits configured for improving the determined approximations of the pixel values. A third stream of bits is generated from the input video frame (1005), according to a bitwise error correction method. The third stream of bits contains parity information, where the first, second and third stream of bits represent the encoded video frame.

### FIELD OF THE INVENTION

The present invention relates generally to video encoding and decoding and, in particular, to a method and apparatus for performing distributed video encoding.

### BACKGROUND

Various products, such as digital cameras and digital video cameras, are used to capture images and video. These products contain an image sensing device, such as a charge coupled device (CCD), which is used to capture light energy focussed on the image sensing device. The captured light energy, which is indicative of a scene, is then processed to form a digital image. Various formats are used to represent such digital images, or videos. Formats used to represent video include Motion JPEG (Joint Photographic Experts Group), MPEG2, MPEG4 and H.264.

All the formats listed above are compression formats. While those formats offer high quality and improve the number of video frames that can be stored on a given media, they typically suffer because of their long encoding runtime.

A complex encoder requires complex hardware. Complex encoding hardware in turn is disadvantageous in terms of design cost, manufacturing cost and physical size of the encoding hardware. Furthermore, long encoding runtime delays the rate at which video frames can be captured while not overflowing a temporary buffer. Additionally, more complex encoding hardware has higher battery consumption. As battery life is essential for a mobile device, it is desirable that battery consumption be minimized in mobile devices.

To minimize the complexity of an encoder, Wyner Ziv coding, or “distributed video coding”, may be used. In distributed video coding the complexity of the encoder is shifted to the decoder. The input video stream is also usually split into key frames and non-key frames. The key frames are compressed using a conventional coding scheme, such as Motion JPEG, MPEG2, MPEG4 or H.264, and the decoder conventionally decodes the key frames. With the help of the key frames, the non-key frames are predicted. The processing at the decoder is thus equivalent to carrying out motion estimation which is usually performed at the encoder. The predicted non-key frames are improved in terms of visual quality with the information the encoder is providing for the non-key frames.

The visual quality of the decoded video stream depends heavily on the quality of the prediction of the non-key frames and the level of quantization to the image pixel values. The prediction is often a rough estimate of the original frame, generated from adjacent frames, e.g., through motion estimation and interpolation. Thus when there is a mismatch between the prediction and the decoded values, some forms of compromise are required to resolve the differences.

To facilitate the generation of the predicted (non-key) frames, a hash function at the encoder is often used to aid motion estimation at the decoder. The hash function operates on transform domains and requires complex transform operations for each image block. Use of such a hash function adds huge complexity to a simple DVC encoder.

### SUMMARY

It is an object of the present invention to substantially overcome, or at least ameliorate, one or more disadvantages of existing arrangements.

According to one aspect of the present invention there is provided a method of encoding an input video frame comprising a plurality of pixel values, to form an encoded video frame, said method comprising the steps of: down-sampling the pixel values of the input video frame to generate a first stream of bits configured for use in subsequent determination of approximations of the pixel values;

extracting samples from predetermined pixel positions based on the input video frame to generate a second stream of bits configured for improving the determined approximations of the pixel values; and

generating a third stream of bits from the input video frame, according to a bitwise error correction method, said third stream of bits containing parity information, wherein said first, second and third stream of bits represent the encoded video frame.

According to another aspect of the present invention there is provided an apparatus for encoding an input video frame comprising a plurality of pixel values, to form an encoded video frame, said apparatus comprising:

down-sampler for down-sampling the pixel values of the input video frame to generate a first stream of bits configured for use in subsequent determination of approximations of the pixel values;

extractor for extracting samples from predetermined pixel positions based on the input video frame to generate a second stream of bits configured for improving the determined approximations of the pixel values; and

coder for generating a third stream of bits from the input video frame, according to a bitwise error correction method, said third stream of bits containing parity information, wherein said first, second and third stream of bits represent the encoded video frame.

According to still another aspect of the present invention there is provided a computer readable medium, having a program recorded thereon, where the program is configured to make a computer encode an input video frame comprising a plurality of pixel values, to form an encoded video frame, said program comprising:

code for down-sampling the pixel values of the input video frame to generate a first stream of bits configured for use in subsequent determination of approximations of the pixel values;

code for extracting samples from predetermined pixel positions based on the input video frame to generate a second stream of bits configured for improving the determined approximations of the pixel values; and

code for generating a third stream of bits from the input video frame, according to a bitwise error correction method, said third stream of bits containing parity information, wherein said first, second and third stream of bits represent the encoded video frame.

According to still another aspect of the present invention there is provided a system for encoding an input video frame comprising a plurality of pixel values, to form an encoded video frame, said system comprising:

a memory for storing data and a computer program; and

a processor coupled to said memory executing said computer program, said computer program comprising instructions for:
down-sampling the pixel values of the input video frame to generate a first stream of bits configured for use in subsequent determination of approximations of the pixel values;
extracting samples from predetermined pixel positions based on the input video frame to generate a second stream of bits configured for improving the determined approximations of the pixel values; and

generating a third stream of bits from the input video frame, according to a bitwise error correction method, said third stream of bits containing parity information, wherein said first, second and third stream of bits represent the encoded video frame.

According to still another aspect of the present invention there is provided a method of decoding an encoded version of an original video frame to determine a decoded video frame, said method comprising the steps of: processing a first stream of bits derived from the original video frame to determine pixel values representing an approximation of the original video frame;

replacing a portion of the pixel values in the approximation with sample values from a second stream of bits derived from predetermined pixel positions of the original video frame; and
correcting one or more pixel values in the approximation using parity information configured within a third stream of bits derived from the original video frame, to determine the decoded video frame.

According to still another aspect of the present invention there is provided an apparatus for decoding an encoded version of an original video frame to determine a decoded video frame, said apparatus comprising:

decompression module for processing a first stream of bits derived from the original video frame to determine pixel values representing an approximation of the original video frame;

sampling module for replacing a portion of the pixel values in the approximation with sample values from a second stream of bits derived from predetermined pixel positions of the original video frame; and
decoder module for correcting one or more pixel values in the approximation using parity information configured within a third stream of bits derived from the original video frame, to determine the decoded video frame.

According to still another aspect of the present invention there is provided a computer readable medium, having a program recorded thereon, where the program is configured to make a computer decode an encoded version of an original video frame to determine a decoded video frame, said program comprising:

code for processing a first stream of bits derived from the original video frame to determine pixel values representing an approximation of the original video frame;

code for replacing a portion of the pixel values in the approximation with sample values from a second stream of bits derived from predetermined pixel positions of the original video frame; and
code for correcting one or more pixel values in the approximation using parity information configured within a third stream of bits derived from the original video frame, to determine the decoded video frame.

According to still another aspect of the present invention there is provided a system for encoding an input video frame comprising a plurality of pixel values, to form an encoded video frame, said system comprising:

a memory for storing data and a computer program; and

a processor coupled to said memory executing said computer program, said computer program comprising instructions for:
processing a first stream of bits derived from the original video frame to determine pixel values representing an approximation of the original video frame;
replacing a portion of the pixel values in the approximation with sample values from a second stream of bits derived from predetermined pixel positions of the original video frame; and
correcting one or more pixel values in the approximation using parity information configured within a third stream of bits derived from the original video frame, to determine the decoded video frame.
Other aspects of the invention are also disclosed.

### BRIEF DESCRIPTION OF THE DRAWINGS

One or more embodiments of the present invention will now be described with reference to the drawings, in which:

FIG. 1a shows schematic block diagram of a system for encoding an input video, for transmitting or storing the encoded video, and for decoding the video, according to an exemplary embodiment;

FIG. 1b shows schematic block diagram of a system for encoding an input video, for transmitting or storing the encoded video, and for decoding the video, according to an alternative embodiment;

FIG. 2 shows a schematic block diagram of a turbo coder of the systems of FIGS. 1a and 1b;

FIG. 3 shows a schematic block diagram of a turbo decoder of the systems of FIGS. 1a and 1b;

FIG. 4 shows a schematic block diagram of a computer system in which the system shown in FIGS. 1a and 1b may be implemented;

FIG. 5 is a flow diagram showing a method performed in a component decoder of the turbo decoder of FIG. 3;

FIG. 6 is intentionally absent;

FIG. 7a is a flow diagram showing a method of encoding an input video frame, in the system of FIG. 1a;

FIG. 7b is a flow diagram showing a method of encoding an input video frame, in the system of FIG. 1b;

FIG. 8 is a flow diagram showing a method of encoding the input video frame; and

FIG. 9 is a flow diagram showing a method of decoding bit-streams to determine an output video frame representing a final approximation of an input video frame.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

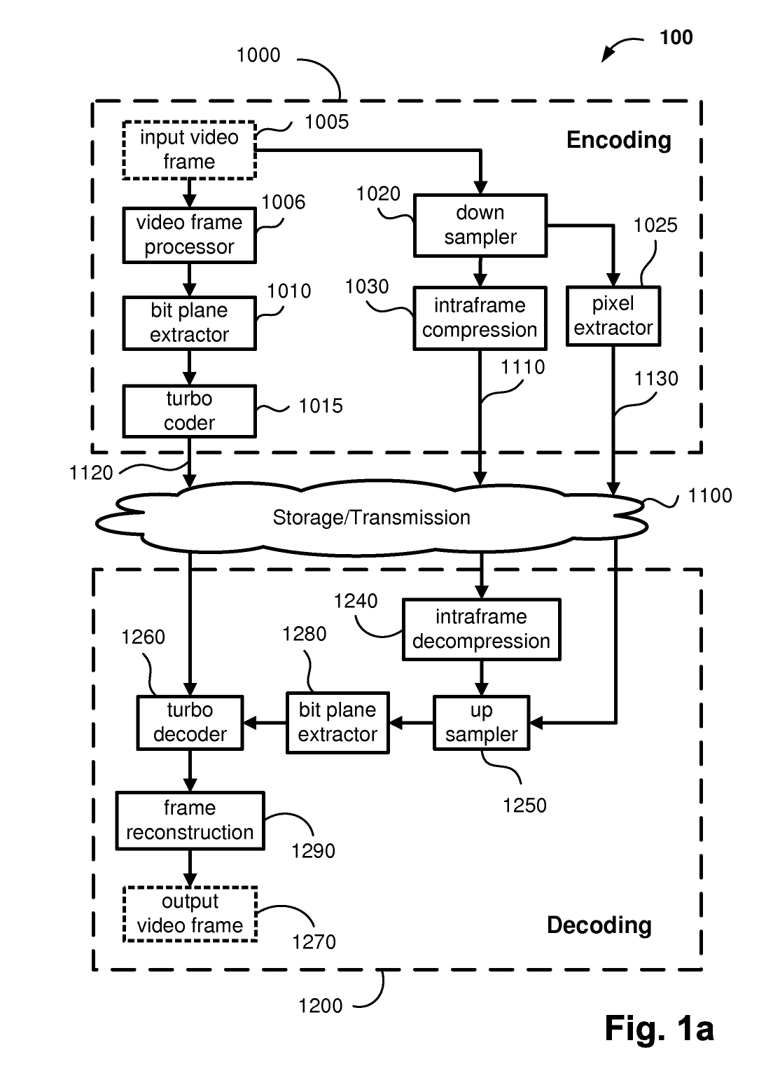

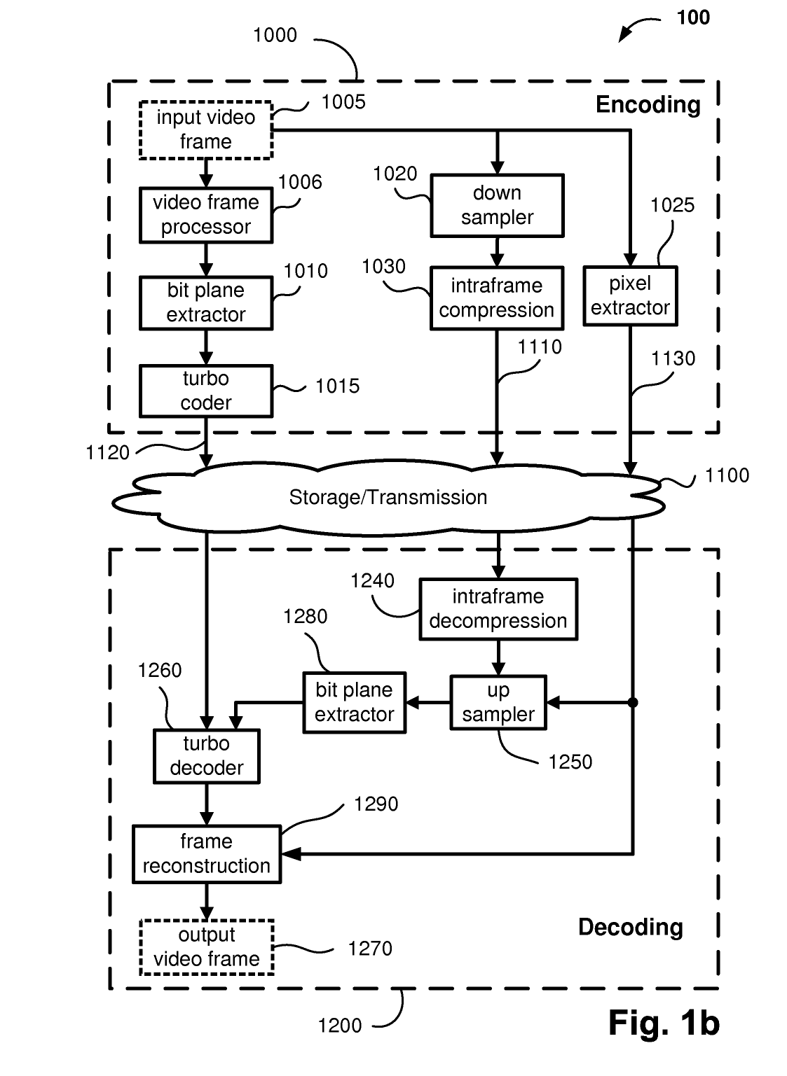

FIG. 1a shows a schematic block diagram of a system 100 for performing distributed video encoding on an input video frame, for transmitting or storing the encoded video frame and for decoding the video frame, according to an exemplary embodiment. The system 100 includes an encoder 1000 and a decoder 1200 interconnected through a storage or transmission medium 1100. The encoder 1000 forms three independently encoded bit-streams 1110, 1120, and 1130 representing an encoded version of the input video frame. The bit-streams 1110, 1120, and 1130 are jointly decoded by the decoder 1200.

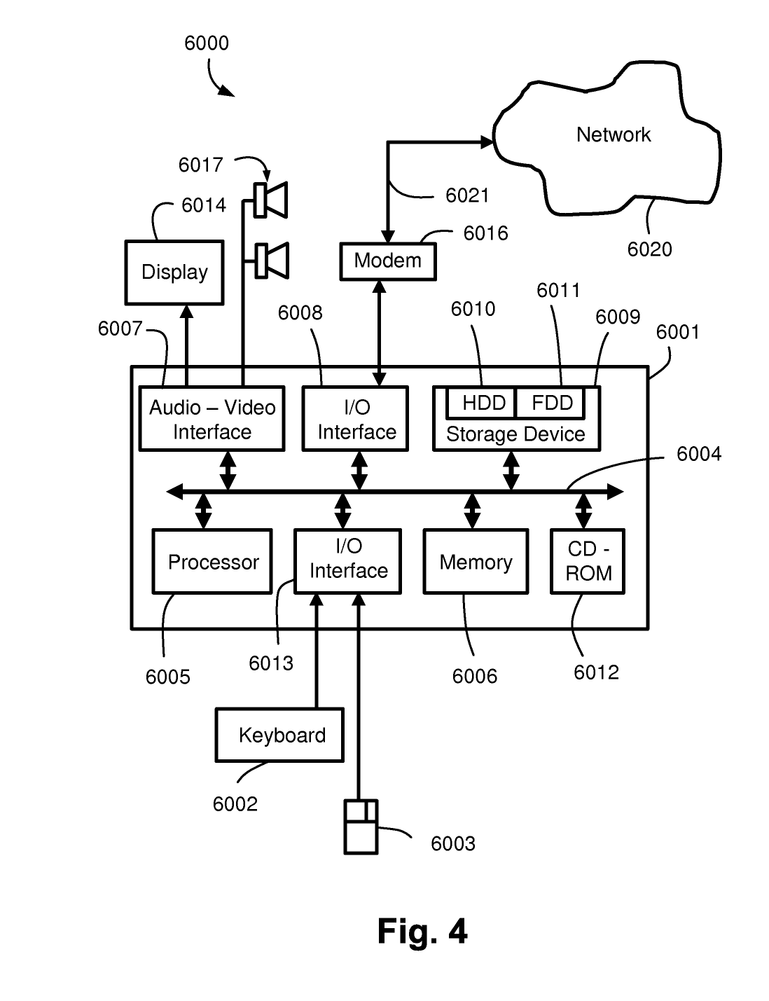

The components 1000, 1100 and 1200 of the system 100 shown in FIG. 1a may be implemented using a computer system 6000, such as that shown in FIG. 4, wherein the encoder 1000 and decoder 1200 may be implemented as software, such as one or more application programs executable within the computer system 6000. As described below, the encoder 1000 comprises a plurality of software modules 1006, 1010, 1015, 1020, 1225 and 1030, each performing specific functions. Similarly, the decoder 1200 comprises a plurality of other software modules 1240, 1250, 1260, 1270, 1280, and 1290, each performing specific functions.

The software modules may be stored in a computer readable medium, including the storage devices described below, for example. The software modules may be loaded into the computer system 6000 from the computer readable medium, and then executed by the computer system 6000. A computer readable medium having such software or computer program recorded on it is a computer program product. The use of the computer program product in the computer system 6000 preferably effects an advantageous apparatus for implementing the described methods.

As shown in FIG. 4, the computer system 6000 is formed by a computer module 6001, input devices such as a keyboard 6002 and a mouse pointer device 6003, and output devices including a display device 6014 and loudspeakers 6017. An external Modulator-Demodulator (Modem) transceiver device 6016 may be used by the computer module 6001 for communicating to and from a communications network 6020 via a connection 6021.

The computer module 6001 typically includes at least one processor unit 6005, and a memory unit 6006. The module 6001 also includes a number of input/output (I/O) interfaces including an audio-video interface 6007 that couples to the video display 6014 and loudspeakers 6017, an I/O interface 6013 for the keyboard 6002 and mouse 6003, and an interface 6008 for the external modem 6016. In some implementations, the modem 6016 may be incorporated within the computer module 6001, for example within the interface 6008. A storage device 6009 is provided and typically includes a hard disk drive 6010 and a floppy disk drive 6011. A CD-ROM drive 6012 is typically provided as a non-volatile source of data.

The components 6005 to 6013 of the computer module 6001 typically communicate via an interconnected bus 6004 and in a manner which results in a conventional mode of operation of the computer system 6000 known to those in the relevant art.

Typically, the application programs discussed above are resident on the hard disk drive 6010 and are read and controlled in execution by the processor 6005. Intermediate storage of such programs and any data fetched from the network 6020 may be accomplished using the semiconductor memory 6006, possibly in concert with the hard disk drive 6010. In some instances, the application programs may be supplied to the user encoded on one or more CD-ROM and read via the corresponding drive 6012, or alternatively may be read by the user from the network 6020. Still further, the software can also be loaded into the computer system 6000 from other computer readable media. Computer readable media refers to any storage medium that participates in providing instructions and/or data to the computer system 6000 for execution and/or processing. The system 100 shown in FIGS. 1a and 1b may alternatively be implemented in dedicated hardware such as one or more integrated circuits. Such dedicated hardware may include graphic processors, digital signal processors, or one or more microprocessors and associated memories.

In one implementation, the encoder 1000 and decoder 1200 are implemented within a camera (not illustrated), wherein the encoder 1000 and the decoder 1200 may be implemented as software being executed by a processor of the camera, or may implemented using hardware within the camera.

In a second implementation, only the encoder 1000 is implemented within a camera, wherein the encoder 1000 may be implemented as software executing in a processor of the camera, or implemented using hardware within the camera.

Referring again to FIG. 1a, a video frame 1005 of an input video is received as input to the system 100. The video frame 1005 comprises a plurality of pixel values. Preferably, every input video frame 1005 is processed by the system 100. In an alternative embodiment, every fifth input video frame is encoded using the system 100. In yet another alternative embodiment, a selection of input video frames 1005 is made from the input video, with the selection of the input video frame 1005 depending on the content of the input video. For example, if an occlusion of an object represented in the input video is observed, and if the extent of the observed occlusion is found to be above a threshold, then the input video frame 1005 is encoded using the system 100.

In the exemplary embodiment, as shown in FIG. 1a, the encoder 1000 encodes the input video frame 1005 to generate a first stream of bits in the form of a bit-stream 1110. A method 700 of encoding the input video frame 1005 will now be described with reference to FIGS. 1a and 7a. The method 700 may be implemented as software in the form of a down-sampler module 1020, a pixel extractor module 1025, and an intra-frame compression module 1030. The software is preferably resident on the hard disk drive 6010 and is controlled in its execution by the processor 6005.

The method 700 begins at step 701, where the encoder 1000, executed by the processor 6005, performs the step of down-sampling the pixel values of the input video frame 1005 using the down-sampler module 1020 to form a down-sampled version of the input video frame 1005. The down sampled version of the input video frame 1005 may be stored in the memory and/or the storage device 6009. At the next step 703, the encoder 1000, executed by the processor 6005, performs the step of compressing the down-sampled version of the input video frame 1005 using the intra-frame compression module 1030 to generate the bit-stream 1110. As will be described below, the bit-stream 1110 is configured for use by an intraframe decompression module 1240 in subsequent determination of approximations of the pixel values of the input video frame 1005.

In addition, the encoder 1000, in step 705, performs the step of extracting samples of pixel values from the down-sampled version of the original input video frame 1005 using the pixel extractor module 1025 to generate a second stream of bits in the form of the bit-stream 1130. As will be described below, the bit-stream 1130 is configured for use by an up-sampler module 1250 in improving determined approximations of the pixel values of the input video frame 1005. Further, the bit-stream 1130 may be generated based on predetermined pixel positions of the input video frame 1005. Both bit-streams 1110 and 1130, are transmitted over, or stored in, the storage or transmission medium 1100 for decompression by the decoder 1200. The bit-streams 1110 and 1130 may be stored in the memory 6006 and/or the storage device 6009.

In another embodiment of the system 100, as shown in FIG. 1b, the samples of pixel values (i.e., bit-stream 1130) may be extracted by the pixel extractor module 1025 directly from the input video frame 1005 instead of from the down-sampled input video frame to generate the bit-stream 1130. In this instance, the compression method 700 may be simplified, as shown in FIG. 7b, to only include step 701 and step 703 as described above.

In a still further embodiment, the samples of pixel values may be compressed using conventional compression methods (e.g., Arithmetic Coding and run-length coding), in order to form the compressed bit-stream 1130.

Referring again to the exemplary embodiment, the down-sampler module 1020 comprises a down-sampling filter with a cubic kernel. The down-sample module 1020 performs the down sampling at a down-sampling rate of two, meaning that the resolution is reduced to one half of the original resolution in both the horizontal and vertical dimensions. However, a different down-sampling rate may be defined (e.g., by a user). Alternative down-sampling methods may also be used by the down-sampler module 1020, such as nearest neighbour, bilinear, bi-cubic, and quadratic down-sampling filters using various kernels such as Gaussian, Bessel, Hamming, Mitchell or Blackman kernels.

The compression method used by the intra-frame compression module 1030 may be baseline mode JPEG compression, compression according to the JPEG2000 standard, or compression according to the H.264 standard.

Independently from the down-sampling in the down-sampler module 1020, the encoder 1000, executed by the processor 6005, performs the step of generating a third stream of bits in the form of the bit-stream 1120 from the input video frame 1005. The bitsteam 1120 is generated according to a bitwise error correction method. The bit-stream 1120 may be stored in the memory 6006 and/or the storage device 6009.

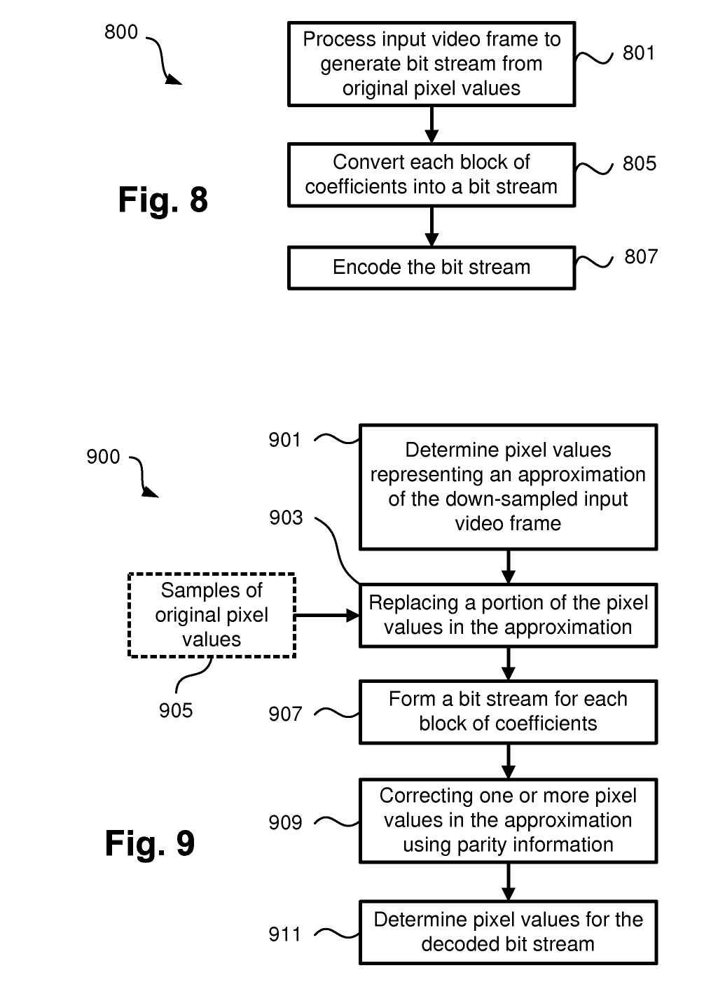

A method 800 of encoding the input video frame 1005 to generate the bit-stream 1120 will now be described with reference to FIG. 8. The method 800 may be implemented as software in the form of a video frame processor module 1006, a bit plane extractor module 1010, and a turbo coder module 1015. The software is preferably resident on the hard disk drive 6010 and is controlled in its execution by the processor 6005.

The method 800 begins at the first step 801, where the input video frame 1005 is firstly processed by the video frame processor module 1006. The video frame processor module 1006, executed by the processor 6005, performs the step of generating a bit-stream from original pixel values of the input video frame 1005. The video frame processor module 1006 may partition the original pixel values of the input video frame 1005 into one or more blocks of pixels. The pixels of each block of pixels may then be scanned by the video frame processor module 1006 in an order representing the spatial positions of the pixels in the block. For example, the pixels of each block may be scanned ‘scanline by scanline’, ‘column by column’ or in a ‘raster scan order’ (i.e., in a zig-zag order) from the top to the bottom of the block of pixels. The video frame processor module 1006 produces a bit-stream which is highly correlated with the original pixels of the input video frame 1005. The bit-stream produced by the video frame processor module 1006 may be stored in the memory 6006 and/or the storage device 6009.

The bit-stream formed by the video frame processor module 1006 is then input to a bit plane extractor module 1010 where, at the next step 805, each block of coefficients is converted into a bit-stream. The processor 6005 executes the bit plane extractor module 1010 to perform the step of forming a bit-stream for each block of coefficients from the bit-stream generated by the video frame processor module 1006. Preferably, scanning starts on the most significant bit plane of the video frame 1005 and the most significant bits of the coefficients of the frame 1005 are concatenated to form a bit-stream containing the most significant bits.

In a second pass, the scanning concatenates the second most significant bits of all coefficients of the input video frame 1005. The bits from the second scanning path are appended to the bit-stream generated in the previous scanning path. The scanning and appending continues in this manner for all lower bit planes. This generates a complete bit-stream for each input video frame 1005. The bit plane extractor 1010 may generate such a complete bit-stream from predetermined pixel positions of the input video frame 1005. For example, in the exemplary embodiment, the bit plane extractor module 1010 extracts every pixel in the input video frame 1005. However, in an alternative embodiment, not every pixel is processed. In this instance, the bit plane extractor module 1010 is configured to extract a predetermined subset of pixels within each bit plane to generate a bit-stream which contains bits for spatial resolutions lower than the original resolution. In yet another embodiment, the bit plane extractor module 1010 may include a pre-processing step of discarding the sample pixel values that form the bit-stream 1130 from the bit-stream output from the video frame processor module 1006.

At the next step 807, the turbo coder module 1015, executed by the processor to 6005, performs the step of encoding the bit-stream output from the bit plane extractor module 1010. The bit-stream is encoded by the turbo coder module 1015 according to a bitwise error correction method. The turbo coder module 1015 generates a bit-stream 1120 containing parity information in the form of parity bits. The turbo encoder module 1015 generates parity bits at step 807 for each single bit plane of the input video frame 1005. Accordingly, if the bit depth of the input video frame 1005 is eight, then eight sets of parity bits can be produced of which each parity bit set refers to one bit plane only. The bit-stream 1120, including the parity bits, output by the turbo encoder 1015 is then transmitted over a storage or transmission medium 1100 in the bit-stream 1120. The bit-stream 1120 may also be stored in the memory 6006 and/or the storage device 6009. The bit-stream 1120 containing the parity information is configured for use by a turbo decoder module 1260 in performing error correction in subsequent decoding of the encoded input video frame 1005.

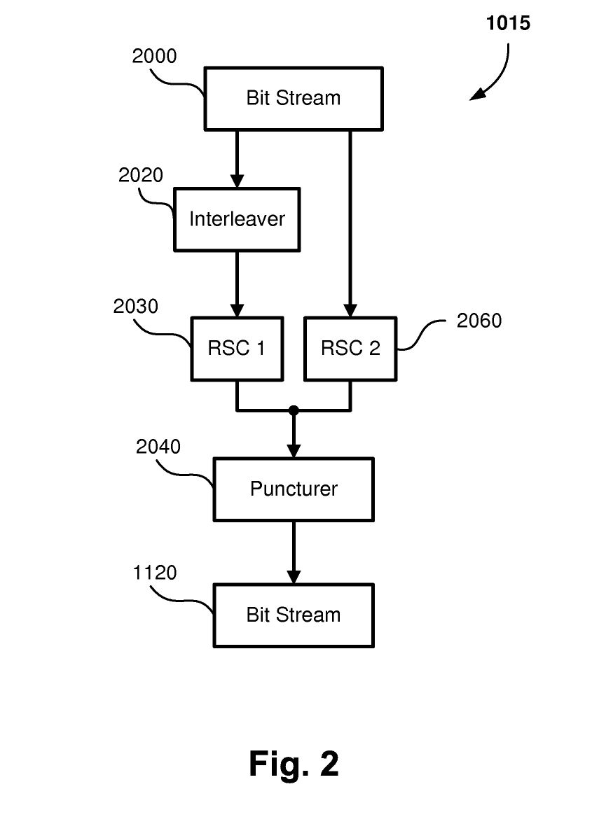

The operation of the turbo coder module 1015 is described in greater detail with reference to FIG. 2.

The encoder 1000 thus forms three bit-streams 1110, 1120 and 1130, all derived from the same input video frame 1005. Accordingly, each of the bit-streams 1110, 1120, and 1130 represents at least a portion of the encoded video frame 1005. The bit-streams 1110, 1120, and 1130 may be multiplexed into a single bit-stream representing the encoded video frame 1005. This single bit-stream may be stored in, or transmitted over the storage or transmission medium 1100. The single bit-stream may also be stored in the memory 6006 and/or the storage device 6009.

Having described an overview of the operation of the encoder 1000, an overview of the operation of the decoder 1200 is described below. The decoder 1200 receives three inputs; the first input is the bit-stream 1120 from the turbo coder module 1015, the second input is the bit-stream 1110 from the intra-frame compression module 1030, and the third input is the bit-stream 1130 from the pixel extractor module 1025.

A method 900 of decoding the bit-streams 1110, 1120, and 1130 representing the compressed input video frame 1005 to determine an output video frame 1270 representing a final approximation of the input video frame 1005, will now be described with reference to FIG. 9. The method 900 may be implemented as software in the form of an intra-frame decompression module 1240, an up-sampler module 1250, a bit plane extractor 1280, a turbo decoder 1260, and a frame reconstruction module 1290. The software is preferably resident on the hard disk drive 6010 and is controlled in its execution by the processor 6005.

In the exemplary embodiment, the method 900 begins at the first step 901, where the bit-stream 1110 is processed by an intra-frame decompressor module 1240 which performs the inverse operation to the intra-frame compression module 1030. The intra-frame decompressor module 1240, executed by the processor 6005, performs the step of processing the bit-stream 1110 derived from the original input video frame 1005 to determine pixel values representing approximations of the pixel values of the down-sampled version of the input video frame 1005. The pixel values may be stored in the memory 6006 and/or the storage device 6009.

The up-sampler module 1250 has two inputs: the approximations of the pixel values of the down-sampled video frame from step 901 and the sample pixel values from the bit-stream 1130 derived from the input video frame 1005. At the next step 903, the up-sampler module 1250, executed by the processor 6005, uses the bit-stream 1130 in improving the approximations of the pixel values of the down-sampled video frame. The up-sampler module 1250 first performs the step of replacing a portion of the pixel values in the approximation of the down-sampled video frame with the sample pixel values from the bit-stream 1130. The up-sampler module 1250 then performs the step of up-sampling to a resulting down-sampled version of the input video frame 1005. Preferably a cubic filter is used during the up-sampling. The up-sampling method used by up-sampler module 1250 does not have to be the inverse of the down-sampling method used by the down-sampler module 1020. For example, a bilinear down-sampling and a cubic up-sampling may be used by the up-sampler module 1250. The up-sampler module 1250 may take advantages of the sample pixel values from the bit-stream 1130 to improve the pixel values of the pixels spatially adjacent to the sample pixels. The up-sampler module 1250 outputs a bit-stream representing an approximation of the input video frame 1005. The bit-stream output by the up-sampler module 1250 may be stored in the memory 6006 and/or the storage device 6009.

Then in step 907, the bit-stream output from the up-sampler module 1250 is input to a bit plane extractor module 1280 which is substantially identical to the bit plane extractor module 1010 of the encoder 1000. The bit plane extractor module 1280, executed by the processor 6005, performs the step of forming a bit-stream for each block of coefficients from the bit-stream output by the up-sampler module 1250. The bit-stream output by the bit plane extractor module 1280 may be buffered within the memory 6006 and/or the storage device 609 for later decoding.

In the embodiment of FIG. 1b, where the samples of original pixel values are extracted directly from the input video frame 1005, the up-sampler module 1250, in step 903, performs the step of up-sampling to the approximation of the down-sampled version of the input video frame. In this instance, the sample pixel values derived from the bit-stream 1130 form side information. A bit-stream output by the up-sampler module 1250 is thus a first approximation of the input video frame 1005. The samples of the original pixel values being input to step 903, in accordance with the embodiment of FIG. 1b, is represented by the broken lined box 905 of FIG. 9.

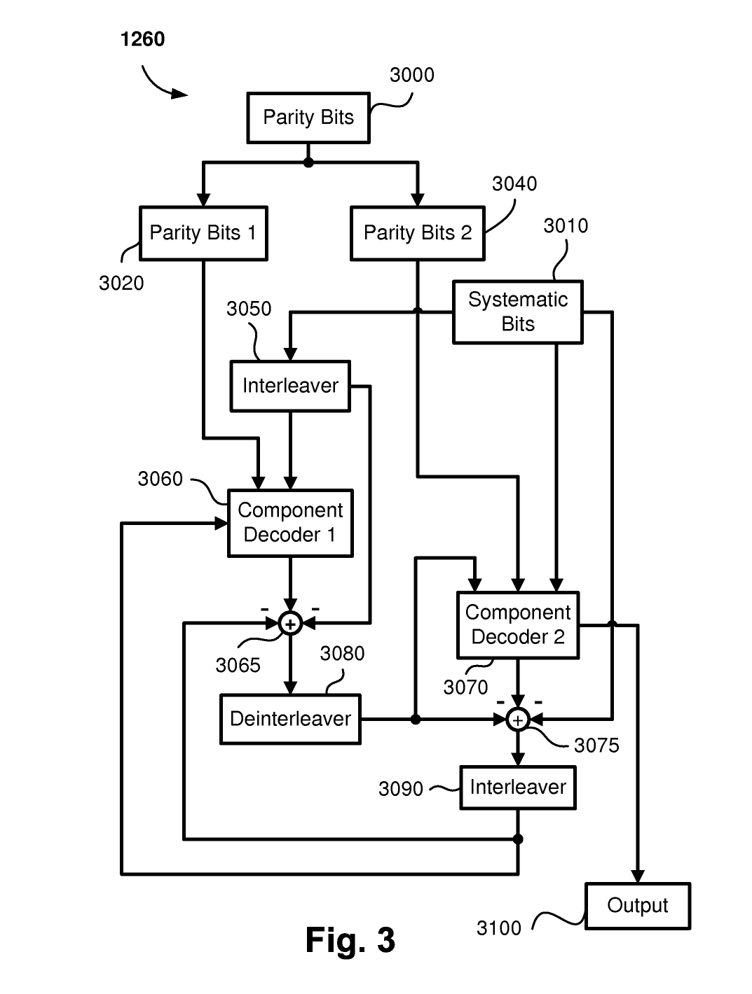

The decoder 1200 further includes a turbo decoder module 1260, which is described in detail below with reference to FIG. 3. The turbo decoder module 1260 operates on each bit plane of the bit-stream 1120 in turn to correct at least a portion of each bit plane. In a first iteration, the turbo decoder module 1260 receives the parity bits for the first (most significant) bit plane from the bit-stream 1120 as input. The turbo decoder module 1260 also receives the first bit plane from the bit-stream output from the bit plane extractor module 1280 as side information. The turbo decoder module 1260 uses the parity bits (or parity information) for the first bit plane to improve the approximation (or determine a better approximation) of the first bit plane of the input video frame 1005. The turbo decoder module 1260 outputs a decoded bit-stream representing a decoded first bit plane. The decoded bit-stream output by the turbo decoder module 1260 may be stored in the memory 6006 and/or the storage device 6009. The turbo decoder module 1260 repeats the above process repeats for lower bit planes until all bit planes are decoded.

Accordingly, at step 909, the turbo decoder module 1260, executed by the processor 6005, performs the step of correcting one or more pixel values in the approximation of each of the bit planes using the parity information configured within the bit-stream 1120 derived from the original input video frame 1005. The turbo decoder module 1260 determines a decoded bit-stream representing a better approximation of the original input video frame 1005.

At the next step 911, the frame reconstruction module 1290, executed by the to processor 6005, then processes the decoded bit-stream output by the turbo decoder module 1260 to determine pixel values for the decoded bit-stream. Accordingly, the frame reconstruction module 1290 performs the step of determining pixel values for the decoded bit-stream output by the turbo decoder module 1260. In accordance with the exemplary embodiment, the most significant bits of the coefficients of the frame 1005 are first determined by the turbo decoder module 1260. The second most significant bits of the coefficients of the frame 1005 are then determined and concatenated with the first most significant bits of the coefficients of the frame 1005. This process repeats for lower bit planes until all bits are determined for each bit plane of the frame 1005. The pixel values determined by the frame reconstruction module 1290 may be stored in the memory 6006 and/or the storage device 6009.

In the embodiment of FIG. 1b, the frame reconstruction module 1290 may insert or replace the decoded pixel values with the sample original pixel values derived from the bit-stream 1130. In other embodiments, the frame reconstruction module 1290 may use the bit-stream output of the up-sampler module 1250 and the information produced by the turbo decoder module 1260 to obtain the pixel values for the decoded bit-stream. The resulting pixel values output from the frame reconstruction module 1290 form the output video frame 1270, which is the final approximation of the input video frame 1005. The output video frame 1270 may be stored in the memory 6006 and/or the storage device 6009. The output video frame 1270 may also be displayed on the display 6014.

The down-sampler module 1020 reduces the spatial resolution of the input video frame 1005. In the exemplary embodiment shown in FIG. 1a, the down-sampler module 1020 implements a bi-cubic down-sampling method and the input video frame 1005 is reduced to one half of the original resolution in both horizontal and vertical dimensions. Alternatively, the down-sampler module 1020 may use the nearest neighbour, bilinear, bi-cubic, and quadratic down-sampling filters using various kernels such as Gaussian, Bessel, Hamming, Mitchell or Blackman kernels.

To facilitate the process of up-sampling at the decoder 1200, some original pixels may be stored and transmitted to the storage or transmission medium 1100 for decompression by the decoder 1200.

In the exemplary embodiment, pixels at predetermined positions of the down-sampled version of the input video frame 1005 are extracted by the pixel extractor module 1025 shown in FIG. 1a. In an alternative embodiment, the positions of the predetermined pixel values are transmitted by the pixel extractor module 1025. In yet another alternative embodiment, the choice of extracting only the predetermined pixel values or transmitting positions of extracted pixel values may be selected in real-time on a frame-by-frame basis depending on the context of the current video frame.

Intra-frame coding refers to various lossless and lossy compression methods that are performed relative to information that is contained only within the current frame (e.g., 1005), and not relative to any other frame in a video sequence. Common intra-frame compression methods include baseline mode Joint Photographics Expert Group (JPEG), JPEG-LS, and JPEG 2000. In the exemplary embodiment, the intra-frame compression module 1030 performs lossy JPEG compression. A corresponding JPEG quality factor may be set to eighty five (85) and may be re-defined between zero (0) (i.e., low quality) and one hundred (100) (i.e., high quality) by a user. The higher the JPEG quality factor, the smaller is the quantization step size, and the better is the approximation of the original video frame after decompression at the cost of a larger compressed file.

In addition, in the exemplary embodiment, as shown in FIG. 1a, every input video frame 1005 is a key frame. As such, each input video frame 1005 is processed by the intra-frame compression module 1030. In an alternative embodiment, only every fifth one of the input video frames is a key frame. In this instance, only every fifth one of the input video frames is processed by the intra-frame compression module 1030.

The video frame processor module 1006, executed by the processor 6005, forms a bit-stream from original pixel values of the input video frame 1005, such that groups of bits in the bit-stream are associated with clusters of spatial pixel positions in the input video frame 1005. In the exemplary embodiment, the video processor module 1006 scans the input video frame 1005 in a raster scanning order, visiting each pixel of the input video frame 1005. In alternative embodiments, the scanning path used by the video processor module 1006 may be similar to the scanning path employed in JPEG 2000.

In yet another alternative embodiment, the video processor module 1006 does not visit every pixel of the frame 1005 during scanning. In this instance, the video processor module 1006 is configured to extract a specified subset of pixels within each bit plane of the frame 1005 to generate parity bits for spatial resolutions lower than the original resolution.

The bit plane extractor module 1010 will now be described in more detail. In the exemplary embodiment, the bit plane extractor module 1010, executed by the processor 6005, starts the scanning on the most significant bit plane of the input video frame 1005 and concatenates the most significant bits of the coefficients of the input video frame 1005, to form a bit-stream containing the most significant bits. The bit-stream containing the most significant bits may be stored in the memory 6006 and/or the storage device 6009. In a second pass, the bit plane extractor module 1010 concatenates the second most significant bits of all coefficients of the frame 1005. The bits from the second scanning path are appended to the bit-stream generated in the previous scanning path. The bit plane extractor module 1010 continues the scanning and appending in this manner until the least significant bit plane is completed, so as to generate one bit-stream for each input video frame. The bit-stream for each video frame may be stored in the memory 6006 and/or the storage device 609.

The turbo coder module 1015 is now described in greater detail with reference to FIG. 2 where a schematic block diagram of the turbo coder module 1015 is shown. The turbo coder module 1015 encodes the bit-stream output from the bit plane extractor module 1010 according to a bitwise error correction method. The turbo coder module 1015 receives as input, a bit-stream 2000 (i.e., an information bit-stream) from the bit plane extractor 1010. The bit-stream 2000 may be accessed from the memory 6006 and/or the storage device 6009. An interleaver module 2020 of the turbo coder module 1010 interleaves the bit-stream 2000. In the exemplary embodiment, the interleaver module 2020 is a block interleaver. However, in alternative embodiments any other suitable interleaver may be used. For example, the interleaver module 2020 may be a random interleaver, a pseudo-random interleaver or a circular-shift interleaver.

The interleaver module 2020 outputs an interleaved bit-stream, which is passed on to a recursive systematic coder module 2030. The recursive systematic coder module 2030 produces parity bits. One parity bit per input bit is produced. In the exemplary embodiment, the recursive systematic coder module 2030 is generated using octal generator polynomials seven (7) (i.e., binary 111₂) and five (5) (i.e., binary 101₂).

A second recursive systematic coder module 2060, executed by the processor 6005, operates directly on the bit-stream 2000 from the bit plane extractor module 1010. In the exemplary embodiment the recursive systematic coder modules 2030 and 2060 are substantially identical. Both recursive systematic coder modules 2030 and 2060 output a parity bit-stream to a puncturer module 2040, with each parity bit-stream being equal in length to the input bit-stream 2000.

The puncturer module 2040 deterministically deletes parity bits to reduce the parity bit overhead previously generated by the recursive systematic coder modules 2030 and 2060. Typically, a “half-rate code” is generated by the puncturer module 2040, which means that half the parity bits from each recursive systematic encoder module 2030 and 2060 are punctured. In an alternative embodiment the puncturer module 2040 may depend on additional information, such as the bit plane of the current information bit. In yet another alternative embodiment, the method of reducing the parity bit overhead used by the puncturer module 2040 may depend on the spatial location of a pixel to which the information bit belongs, as well as the frequency content of an area around this pixel.

The turbo coder module 1015 outputs the punctured parity bit-stream 1120, which comprises parity bits produced by recursive systematic coder modules 2060 and 2030.

The turbo decoder module 1260 is now described in detail with reference to FIG. 3 where a schematic block diagram of the turbo decoder module 1260 is shown.

As seen in FIG. 3, parity bits 3000 in bit-stream 1120 are split into two sets of parity bits 3020 and 3040. The set of parity bits 3020 originates from the recursive systematic coder module 2030 (see FIG. 2) and the set of parity bits 3040 originates from the recursive systematic coder module 2060 (see FIG. 2).

The parity bits 3020 are then input to a component decoder module 3060, which preferably uses a Soft Output Viterbi Decoder (SOYA) algorithm. Alternatively, a Max-Log Maximum A Posteriori Probability (MAP) algorithm may be used by the component decoder module 3060. In yet another alternative embodiment, variations of the SOYA or the MAP algorithms may be used by the component decoder module 3060.

Systematic bits 3010 from the bit plane extractor module 1280 are passed as input to an interleaver module 3050. The interleaver module 3050 is also linked to the component decoder module 3060. In a similar manner, the parity bits 3040 are input to a component decoder module 3070, together with the systematic bits 3010.

As can be seen in FIG. 3, the turbo decoder module 1260 comprises a loop formed from the component decoder module 3060, to an adder 3065, to a de-interleaver module 3080, to the component decoder module 3070, to another adder 3075, to interleaver module 3090 and back to component decoder module 3060.

The component decoder module 3060 takes three inputs with the first input being the parity bits 3020. The second input to the component decoder module 3060 are the interleaved systematic bits from the interleaver module 3050. The third input to the component decoder module 3060 are the interleaved systematic bits output from the second component decoder module 3070, modified by the adder 3075 and interleaved in the interleaver module 3090. The component decoder module 3070 provides information to the other component decoder module 3060. In particular, the component decoder module 3070 provides information about likely values of the interleaved systematic bits to be decoded. The information provided by the component decoder module 3070 is typically provided in terms of Log Likelihood Ratios

$$L ( {u}_{k} ) = ln ( \frac{P ( {u}_{k} = + 1 )}{P ( {u}_{k} = - 1 )} ) ,$$

where P(uₖ=+1) denotes the probability that the bit uₖ equals +1 and where P(uₖ=−1) denotes the probability that the bit uₖ equals −1.

In the first iteration of the turbo decoder module 1260, a feedback input from the second component decoder module 3070 to the first component decoder module 3060 does not exist. Therefore, in the first iteration, the feedback input from the second component decoder 3070 is set to zero.

A (decoded) bit-stream produced by the component decoder module 3060 is passed on to adder 3065 where “a priori information” related to the bit-stream is produced. Systematic bits received from the interleaver module 3050 are extracted in the adder 3065. The information produced by the second component decoder module 3070, processed analogously in adder 3075 and interleaved in interleaver module 3090, is extracted by the adder 3065 as well. Left over is the a priori information which provides the likely value of a bit. The a priori information is valuable for the component decoder 3060.

A bit-stream resulting from operation of the adder 3065, is de-interleaved in de-interleaver module 3080, which performs the inverse action of the interleaver module 3050. A de-interleaved bit-stream from de-interleaver module 3080 is provided as input to component decoder module 3070. In the exemplary embodiment, the component decoder module 3070 as well as the adder 3075 work analogously to the component decoder module 3060 and the adder 3065 as described above. A bit-stream output by the adder 3075 is again interleaved in interleaver 3090 and used as input to the first component decoder module 3060 which begins a second iteration of the turbo decoder module 1260.

In the exemplary embodiment, eight iterations between the first component decoder module 3060 and the second component decoder module 3070 are carried out. After completion of the eight iterations a resulting bit-stream 3100 produced from component decoder module 3070 (i.e., the turbo decoder module 1260) is output. The bit stream 3100 produced by the component decoder module 3070 may be stored in the memory 6006 and/or the storage device 6009.

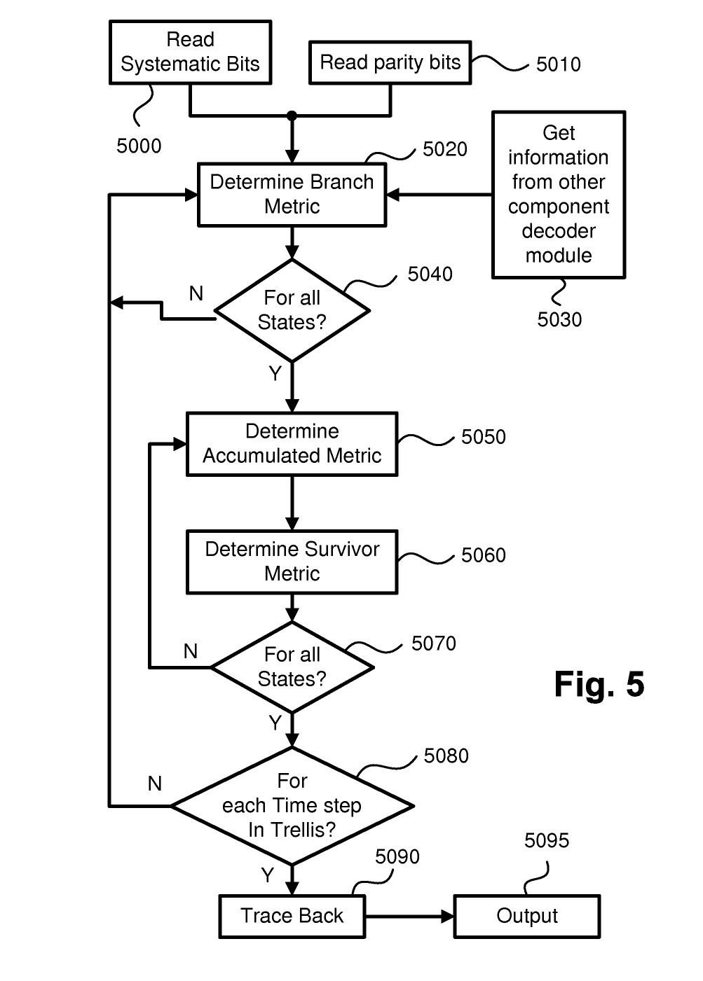

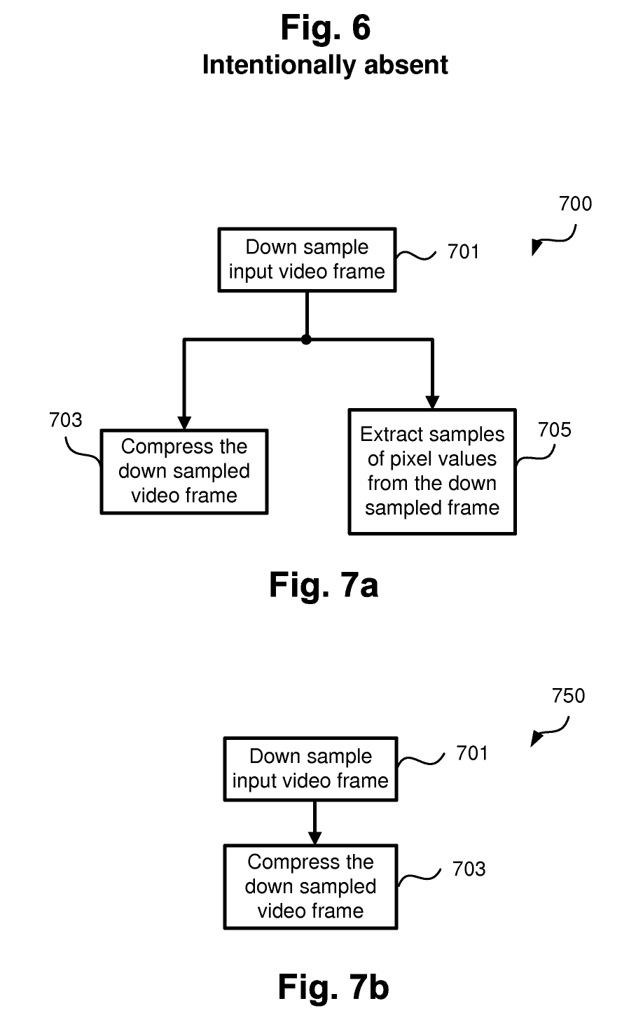

The component decoder module 3060 is now described in more detail with reference to FIG. 5.

FIG. 5 is a schematic flow diagram of a decoding method 500 performed by the component decoder module 3060. The component decoder module 3060 may be implemented as software resident on the hard disk drive 6010 and is controlled in its execution by the processor 6005.

As described above, in the exemplary embodiment, the two component decoder modules 3060 and 3070 need not be identical. However, in the exemplary embodiment, the component decoder modules 3060 and 3070 are substantially identical.

The component decoder module 3060, executed by the processor 6005, commences operation at step 5000 by reading the systematic bits 3010 (see FIG. 3). As described above, the systematic bits 3010 are output by the up-sampler module 1250 and processed by the bit plane extractor 1280.

At step 5010, the parity bits 3020 (see FIG. 3) are read by the component decoder module 3060. The parity bits 3020 may be read from the memory 6006 and/or the storage device 6009.

The method 500 continues in step 5020 where the processor 6005 determines a “branch” metric. The branch metric is a measure of decoding quality for a current code word. The branch metric is zero if the decoding of the current code word is error free. The branch metric will be described in further detail below. Code word decoding errors can sometimes not be avoided and can still result in an overall optimal result.

At step 5030, the component decoder module 3060 determines the branch metric to by getting information from the other component decoder module 3070 (see FIG. 3). The information is in the form of the log likelihood ratios as described above. The log likelihood ratios, and as such the determination of the branch metrics, is based on a model of noise to be expected on the systematic bits 3010. In the exemplary embodiment, a Laplace noise model is used by the component decoder module 3060 to compensate for errors in the systematic bits 3010.

The errors (or noise) to be expected on the systematic bits 3010 originates from a JPEG compression and down and up-sampling. Modelling the noise is generally difficult as reconstruction noise is generally signal dependent (e.g. Gibbs phenomenon) and spatially correlated (e.g. JPEG blocking). As such, errors are not independently, identically distributed. Channel coding methods, such as turbo codes, assume independent, identically distributed noise.

Even though the magnitude of unquantized DC coefficients of discrete cosine transform (DCT) coefficients are generally Gaussian distributed, the magnitude of unquantized AC coefficients may be described by a Laplacian distribution. Quantizing coefficients decreases the standard variation of those Laplacian distributions. As such, noise on DC coefficients may be modelled as Gaussian noise, and noise on AC coefficients may be modelled as Laplace noise. Channel coding methods, such as turbo codes, make an assumption that the noise is additive Gaussian white noise. Thus, it is disadvantageous to use unmodified channel coding methods.

As is evident from FIG. 1a, the systematic bits 3010 used in the determination of the branch metric in step 5020 originate from a spatial prediction process through the up-sampling performed in the up-sampler module 1250.

Referring again to FIG. 5, at the next step 5040, the component decoder module 3060, executed by the processor 6005, determines whether the branch metrics for all states of a trellis diagram corresponding to the component decoder module 3060 have been determined. If the branch metrics for all states have not been determined, then processing returns to step 5020. Otherwise, if the component decoder module 3060 determines at step 5040 that the branch metrics for all states have been determined, then the method 500 continues to step 5050.

At step 5050, the component decoder module 3060, executed by the processor 6005, determines an accumulated branch metric. The accumulated metrics represents the sum of previous code word decoding errors, which is the sum of previous branch metrics. The accumulated branch metric may be stored in the memory 6006 and/or the storage device 6009.

The method 500 continues at the next step 5060, where the component decoder module 3060 determines “survivor path” metrics. The survivor path metrics represents a lowest overall sum of previous branch metrics, indicating an optimal decoding to date.

At the step 5070, the component decoder module 3060 determines whether the survivor path metrics for all states of a trellis diagram corresponding to the component decoder 3060 have been determined. If the survivor path metrics for some states remain to be determined, then the method 500 returns to step 5050. Otherwise, the method 500 proceeds to step 5080.

At the next step 5080, if the component decoder module 3060 determines that the determination of the branch metrics, the determination of the accumulated metric and the determination of the survivor path metrics have been completed, then the method 500 proceeds to step 5090. Otherwise, the method 500 returns to step 5020, where the method 500 returns to step 5020, where the method 500 continues at a next time step in the trellis diagram.

Once the survivor path metric is determined for all nodes in the trellis diagram, the component decoder module 3060 determines a trace back at the next step 5090. In particular, at step 5090, the component decoder module 3060 uses a best one of the decoding branch metrics (i.e., indicating the decoding quality) determined in step 5020 to generate a decoded bit-stream. The method 500 concludes at the final step 5095, where the component decoder module 3060 outputs the decoded bit-stream.

The frame reconstruction module 1290 reconstructs the pixel values from the decoded bit-stream (i.e., 3100) output by the turbo decoder module 1260. In the exemplary embodiment, the most significant bits of the coefficients of the output video frame 1270 are first determined by the turbo decoder module 1260. The second most significant bits of the coefficients of the output video frame 1270 are then determined and concatenated with the first most significant bits. The process performed by the frame reconstruction module 1290 repeats for lower bit planes until all bits are determined for each of the bit planes of the output video frame 1270. In the embodiment of FIG. 1b, samples of original pixel values that form bit-stream 1130 are not encoded by the turbo coder module 1015 at the encoder 1000. The frame reconstruction module 1290 merges the sample pixel values obtained from bit-stream 1130 and the decoded pixel values derived from the output bit-stream of turbo decoder module 1260 to form the output video frame 1270.

The foregoing describes only some embodiments of the present invention, and modifications and/or changes can be made thereto without departing from the scope and spirit of the invention, the embodiments being illustrative and not restrictive. For example, instead of processing the same input video frame 1005 in order to produce the bit-streams to 1110, 1120, and 1130, in an alternative embodiment, bit-stream 1110 may be formed from a key frame of the input video, whereas bit-stream 1120 is formed from non-key frames, and bistream 1130 is generated for all frames. In such an embodiment the data output from up-sampler module 1250 is then an estimate of the non-key frames, and the turbo decoder module 1260 uses the parity data from bit-stream 1120 to correct the estimate.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of encoding an input video frame comprising a plurality of pixel values, to form an encoded video frame, said method comprising the steps of:
down-sampling the pixel values of the input video frame to generate a first stream of bits configured for use in subsequent determination of approximations of the pixel values;
extracting samples from predetermined pixel positions based on the input video frame to generate a second stream of bits configured for improving the determined approximations of the pixel values; and
to generating a third stream of bits from the input video frame, according to a bitwise error correction method, said third stream of bits containing parity information, wherein said first, second and third stream of bits represent the encoded video frame.

2. The method according to claim 1, wherein parity information is produced for each single bit plane of the input video frame.

3. The method according to claim 1, further comprising the step of compressing the down-sampled input video frame to generate the first stream of bits.

4. The method according to claim 1, wherein the samples are extracted from the down-sampled input video frame to generate the first stream of bits.

5. An apparatus for encoding an input video frame comprising a plurality of pixel values, to form an encoded video frame, said apparatus comprising:
down-sampler for down-sampling the pixel values of the input video frame to generate a first stream of bits configured for use in subsequent determination of approximations of the pixel values;
extractor for extracting samples from predetermined pixel positions based on the input video frame to generate a second stream of bits configured for improving the determined approximations of the pixel values; and
coder for generating a third stream of bits from the input video frame, according to a bitwise error correction method, said third stream of bits containing parity information, wherein said first, second and third stream of bits represent the encoded video frame.

6. A computer readable medium, having a program recorded thereon, where the program is configured to make a computer encode an input video frame comprising a plurality of pixel values, to form an encoded video frame, said program comprising:
code for down-sampling the pixel values of the input video frame to generate a first stream of bits configured for use in subsequent determination of approximations of the pixel values;
code for extracting samples from predetermined pixel positions based on the input video frame to generate a second stream of bits configured for improving the determined approximations of the pixel values; and
code for generating a third stream of bits from the input video frame, according to a bitwise error correction method, said third stream of bits containing parity information, wherein said first, second and third stream of bits represent the encoded video frame.

7. A system for encoding an input video frame comprising a plurality of pixel values, to form an encoded video frame, said system comprising:
a memory for storing data and a computer program; and
a processor coupled to said memory executing said computer program, said computer program comprising instructions for:
down-sampling the pixel values of the input video frame to generate a first stream of bits configured for use in subsequent determination of approximations of the pixel values;
extracting samples from predetermined pixel positions based on the input video to frame to generate a second stream of bits configured for improving the determined approximations of the pixel values; and
generating a third stream of bits from the input video frame, according to a bitwise error correction method, said third stream of bits containing parity information, wherein said first, second and third stream of bits represent the encoded video frame.

8. A method of decoding an encoded version of an original video frame to determine a decoded video frame, said method comprising the steps of:
processing a first stream of bits derived from the original video frame to determine pixel values representing an approximation of the original video frame;
replacing a portion of the pixel values in the approximation with sample values from a second stream of bits derived from predetermined pixel positions of the original video frame; and correcting one or more pixel values in the approximation using parity information configured within a third stream of bits derived from the original video frame, to determine the decoded video frame.

9. The method according to claim 8, further comprising the step of producing parity information for each single bit plane of the original video frame.

10. The method according to claim 8, further comprising the step of compressing the original video frame to generate the first stream of bits.

11. The method according to claim 8, wherein the samples are extracted from the original video frame to generate the first stream of bits.

12. An apparatus for decoding an encoded version of an original video frame to determine a decoded video frame, said apparatus comprising:
decompression module for processing a first stream of bits derived from the original video frame to determine pixel values representing an approximation of the original video frame;
sampling module for replacing a portion of the pixel values in the approximation with sample values from a second stream of bits derived from predetermined pixel positions of the original video frame; and
decoder module for correcting one or more pixel values in the approximation using parity information configured within a third stream of bits derived from the original video frame, to determine the decoded video frame.

13. A computer readable medium, having a program recorded thereon, where the program is configured to make a computer decode an encoded version of an original video frame to determine a decoded video frame, said program comprising:
code for processing a first stream of bits derived from the original video frame to determine pixel values representing an approximation of the original video frame;
code for replacing a portion of the pixel values in the approximation with sample values from a second stream of bits derived from predetermined pixel positions of the original video frame; and
code for correcting one or more pixel values in the approximation using parity information configured within a third stream of bits derived from the original video frame, to determine the decoded video frame.

14. A system for encoding an input video frame comprising a plurality of pixel values, to form an encoded video frame, said system comprising:
a memory for storing data and a computer program; and
a processor coupled to said memory executing said computer program, said computer program comprising instructions for:
processing a first stream of bits derived from the original video frame to determine pixel values representing an approximation of the original video frame;
replacing a portion of the pixel values in the approximation with sample values from a second stream of bits derived from predetermined pixel positions of the original video frame; and
correcting one or more pixel values in the approximation using parity information configured within a third stream of bits derived from the original video frame, to determine the decoded video frame.
